(19) United States
(12) Patent Application Publication
(10) Pub. No.: US 2026/0346380 A1
(43) Pub. Date: Nov. 5, 2026

(54) LASER WELDING METHOD FOR ENHANCING GLASS-METAL JOINING BY ULTRASONICALLY SPRAYING NANOPARTICLES

(71) Applicant: Nanjing University of Aeronautics and Astronautics, Nanjing (CN)

(72) Inventors: Xiong Zhang, Nanjing (CN); Xiaohong Zhan, Nanjing (CN); Yanqiu Zhao, Nanjing (CN)

(21) Appl. No.: 19/704,902

(22) Filed: Jun. 11, 2026

(30) Foreign Application Priority Data
Dec. 10, 2025 (CN) 202511850961.6

(51) Int. Cl. B23K 26/70; B05B 17/06; B23K 26/21; B23K 26/324

(52) U.S. Cl. CPC B23K 26/702; B05B 17/06; B23K 26/21; B23K 26/324

(57) ABSTRACT

Provided is a laser welding method for enhancing glass-metal joining by ultrasonically spraying nanoparticles. According to the method, nanoparticles are introduced to fill an irregular rough surface of a joining interface. A thickness of a nanoparticle layer can be controlled by adjusting process parameters, which greatly reduces a requirement for interfacial polishing precision, so that successful ultrafast laser welding can be achieved on an interface with high surface roughness. The process flow is simplified, a technical barrier is reduced, and joining efficiency is improved. The method can achieve stable interfacial joining without applying high external pressure. The reason is that nanoparticles selected based on first principles can chemically react with an element in a metal or glass to form a metallurgical bonding layer, which greatly improves joining efficiency and joining strength.

### CROSS-REFERENCE TO RELATED APPLICATION

This patent application claims the benefit and priority of Chinese Patent Application No. 202511850961.6 filed with the China National Intellectual Property Administration on Dec. 10, 2025, the disclosure of which is incorporated by reference herein in its entirety as part of the present application.

### TECHNICAL FIELD

The present disclosure belongs to the technical field of precision packaging, and in particular to a laser welding method for enhancing glass-metal joining by ultrasonically spraying nanoparticles.

### BACKGROUND

A glass-metal precision packaging structure is widely used in an integrated circuit, precision optics, new energy, and other industries. High-quality micro-nano joining at a glass-metal interface is the key to ensuring service performance of the precision packaging structure. To achieve high-quality micro-nano joining at the glass-metal interface, it is necessary to control an interfacial gap between the two materials. Ultrafast laser welding features “ultra-short pulse duration”, and “ultra-high energy density and ultra-high photon density”. These characteristics enable the pulsed laser to generate extremely high thermal accumulation within an ultra-short time during interaction with materials, and the ultrafast laser welding has been applied to direct glass-to-metal welding. However, to achieve successful joining, stringent requirements are imposed on the glass-metal interfacial gap, which typically needs to reach optical contact (in existing research, an interfacial gap smaller than λ/4 is defined as optical contact, where λ refers to a wavelength of the adopted pulsed laser), and an external force is required for compression. Therefore, for metallic materials with high roughness, fine polishing and compression treatment must be adopted, which leads to complex procedures, high costs, and long cycles. Moreover, the joining strength and stability are still insufficient, and cracks tend to occur under high stress.

### SUMMARY

An objective of the present disclosure is to provide a laser welding method for enhancing glass-metal joining by ultrasonically spraying nanoparticles, thereby solving the foregoing problems.

To implement the foregoing objective, the present disclosure provides the following technical solutions: a laser welding method for enhancing glass-metal joining by ultrasonically spraying nanoparticle includes a laser welding head, and an atomizing spraying device is disposed on the laser welding head;

specific steps of the method are as follows:
S1. selection of nanoparticles: screening for appropriate nanoparticles by means of first principles;
S2: nano-spraying, including preparation of a nanoparticle dispersion solution, setting of ultrasonic parameters, and atomizing treatment of the dispersion solution;
S3: coating parameter control: controlling a thickness and uniformity of a sprayed coating by controlling parameters such as ultrasonic power and frequency, treatment time, and a solution concentration, wherein a rough metal surface is filled with the nanoparticles, and interfacial gaps are greatly reduced;
S4: pre-welding cleaning: cleaning the glass surface with ultrasonic waves to reduce impurities; and
S5: laser welding: finally, spraying the nanoparticles around the laser welding head by using the atomizing spraying device, followed by laser welding.

Preferably, matching principle of the binding energy magnitude and thermodynamic properties specifically includes the following steps:
Step one: determining physical parameters of glass and metal, where the physical parameters specifically include a lattice parameter, a thermal expansion coefficient, and chemical composition;
Step two: constructing a glass-nanoparticle-metal interfacial atomic model using Material studio software based on the first principles, performing structural optimization on the interfacial model, calculating total energy E_{interface} of a glass-nanoparticle-metal system, and then calculating bonding energy E_{binding} of an interface by using the following formula; and screening for nanoparticles with high bonding energy by comparing interfacial bonding energy values of different nanoparticles;

$${E}_{b i n d i n g} = \frac{{E}_{interface} - ( {E}_{glass} + {E}_{m e t a l} + {E}_{nanopartical} )}{A} ;$$

Step three: as brittle cracking is a common problem during a glass-metal joining process, selecting nanoparticles while considering whether a thermal expansion coefficient (α_{nanoparticle}) of nanoparticles is close to a thermal expansion coefficient (α_{glass}) of the glass or a thermal expansion coefficient (αₘₑₜₐₗ) of a metal substrate, thereby avoiding interface cracking caused by thermal stress after welding; and screening for optimal nanoparticles by comparing similarity in thermal expansion coefficient between different nanoparticles and the metal substrate.

Preferably, in S3, the ultrasonic power determines intensity and efficiency of liquid atomization, the higher the power, the higher the atomization intensity, the faster the liquid is dispersed into droplets, the higher the power, the higher the atomization efficiency, the greater the spraying rate, and the thicker the coating. However, excessively high power may cause droplet spattering, resulting in increased coating surface roughness and degraded uniformity.

Preferably in S3, the ultrasonic frequency mainly affects atomization effect of the liquid, and determines size and distribution of the droplets, the ultrasonic waves with a higher frequency produce smaller droplets, and a diameter of the droplet is inversely proportional to the frequency; in general, the smaller the droplet, the better the uniformity of the coating, but excessively high frequency may result in overly fine droplets, accelerated evaporation, and reduced coating thickness, so that the frequency is inversely proportional to a thickness of the coating and positively correlated with the uniformity;
treatment time: that is spraying time, the longer the time, the greater the coating thickness; and
solution concentration: the greater the solution concentration, the higher a solid particle content in the sprayed coating; and the higher the concentration, the thicker the coating.

Preferably, the welding head includes a first housing, a laser welding head, and nanoparticle spray heads; the first housing is configured to connect an external device, the laser welding head is mounted at the bottom of the first housing for laser welding, the nanoparticle spray heads are annularly arranged around the laser welding head for nanoparticle spraying; the first housing is provided with the atomizing spraying device, the nanoparticle spray heads communicate with the atomizing spraying device, and the atomizing spraying device is configured to supply the dispersion solution to the nanoparticle spray heads.

Preferably, the atomizing spraying device includes a main pipe for externally connecting a liquid pump, and the bottom of the main pipe communicates with the plurality of nanoparticle spray heads for dispersion solution supply; a mounting groove is provided in the atomizing spraying device, a partition plate is disposed inside the mounting groove, and a movable block is slidingly connected to the bottom of the partition plate; a push bar is fixed to the bottom of the movable block, and electric push rods are connected to at least two mutually perpendicular shafts of the movable block for transverse pushing and longitudinal pushing; and the electric push rod is in contact with an outer surface of the movable block without being connected thereto.

Preferably, the bottom of the push bar is provided with two staggered rocker assemblies, a top surface of each of the two rocker assemblies is V-shaped, and the V-shaped surface faces the push bar; the rocker assembly is pried by the movement of the push bar to form a rocker state, enabling the push bar to move to one side to pry one end of the corresponding rocker assembly and enabling the other end of the rocker assembly to tilt upward; and a branch at the bottom of the main pipe is correspondingly plugged by a plugging assembly.

Preferably, a sphere is disposed at the center of the rocker assembly; the rocker assembly is slidably disposed inside the first housing, a sliding chute is arc-shaped for supporting the rocker assembly while allowing the rocker assembly to slide; one of the rocker assemblies is provided with two arc-shaped structures, and a diameter of the arc-shaped structure is greater than an arc diameter of the other rocker assembly; and a plurality of arc-shape structures of the rocker assembly are connected to the sphere via a universal joint.

Preferably, the plugging assembly includes a plurality of branch pipes connected to the main pipe and communicate with the plurality of nanoparticle spray heads through the plurality of branch pipes, and a middle plugging member is arranged on an outer side of the branch pipe;
the middle plugging member includes a second housing connected to the outside of the main pipe, a return pipe connected to one end of the main pipe via a tee valve is further disposed inside the second housing, movable plugging members are vertically disposed on the branch pipe; a plurality of movable plugs are respectively connected to arc-shaped tops of the plurality of rocker assemblies via universal joints, and are slidably connected to the partition plate; and the movable plugging member is driven to move by the upward tilting of one end of the rocker assembly to plug the branch pipe, thereby cutting off liquid supply to the corresponding nanoparticle spray head.

The present disclosure has technical effects as follows: 1. According to the method, nanoparticles are introduced to fill an irregular rough surface of a joining interface. A thickness of a nanoparticle layer can be controlled by adjusting process parameters, which greatly reduces a requirement for interfacial polishing precision, so that successful ultrafast laser welding can be achieved on an interface with high surface roughness, and there is no need to reduce interfacial roughness to Ra<λ/4 by grinding and polishing. The process flow is simplified, a technical barrier is reduced, and joining efficiency is improved.

2. Secondly, the method can achieve stable interfacial joining without relying on high-strength external pressure. The reason is that nanoparticles selected based on first principles can chemically react with an element in a metal or glass to form a metallurgical bonding layer, which greatly improves joining efficiency and joining strength. In a case of not applying an external force for compressing, uneven stress caused by application of the external pressure and the consequent cracking can be effectively avoided, ensuring uniformity and reliability of a joint interface.

3. The atomizing spraying device is provided to synchronize movement of a rear end of the welding head by using the electric push rod during laser welding. When the welding head moves to one side, the electric push rod extends to one end or retracts accordingly, so that the push bar can be used to push the corresponding rocker assembly to tilt up, causing an arc-shaped structure on a rear side of a moving direction thereof to jack up the movable plugging member connected to the top of the arc-shaped structure to plug a corresponding branch pipe. This enables the nanoparticle spray heads located behind the moving direction to stop spraying, thereby reducing waste while ensuring uniform spraying.

4. When the movable plugging member moves upward to block the branch pipe, that is, the push bar moves toward the V-shaped surface of the rocker assembly without coming into contact with the same, a through hole is synchronously moved to the return pipe, the liquid supply of the nanoparticle spray head at this position is cut off, but the liquid here is collected by the return pipe and flows back to the liquid pump for recycling. When a welding moving speed increases, a push distance of the corresponding electric push rod becomes longer, leading to the increase in a jack-up height of the movable plugging member. When the branch pipe is plugged, the return pipe is further plugged gradually, so that the total liquid flow rate of the main pipe remains unchanged, and the delivery pressure of the other three paths of dispersion solution increases, promoting to match the welding speed and improving spraying efficiency.

### BRIEF DESCRIPTION OF THE DRAWINGS

FIG. 1 is a diagram of ultrasonic spraying principle according to the present disclosure;

FIG. 2 is a diagram of an optical path principle structure according to the present disclosure;

FIG. 3 is a flowchart of the present disclosure;

FIG. 4 is a structural diagram of a laser welding head according to the present disclosure;

FIG. 5 is a diagram of a mounting structure of an atomizing spraying device according to the present disclosure;

FIG. 6 is a diagram of an internal structure of an atomizing spraying device according to the present disclosure;

FIG. 7 is a diagram of a partial structure of part A in FIG. 6 according to the present disclosure.

FIG. 8 is a diagram of a detailed structure of a middle plugging member according to the present disclosure;

FIG. 9 is a perspective view of a rocker assembly according to the present disclosure.

In the drawings: 1: first housing; 2: laser welding head; 3: nanoparticle spray head; 4-atomizing spraying device; 401: mounting groove; 402: middle plugging member; 4021: second housing; 4022: telescopic sealing cover; 4023: movable plugging member; 4024: through hole; 4025: branch pipe; 4026: return pipe; 403: main pipe; 404: partition plate; 405: movable block; 406: push bar; 407: rocker assembly; 408: electric push rod; 409: sphere.

### DETAILED DESCRIPTION OF THE EMBODIMENTS

The following clearly and completely describes technical solutions in embodiments of the present disclosure with reference to accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

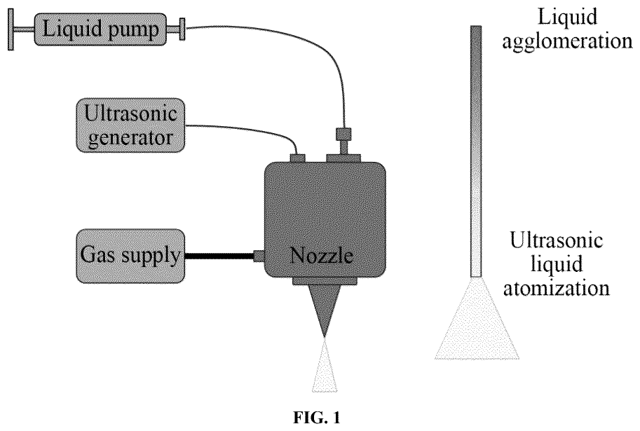

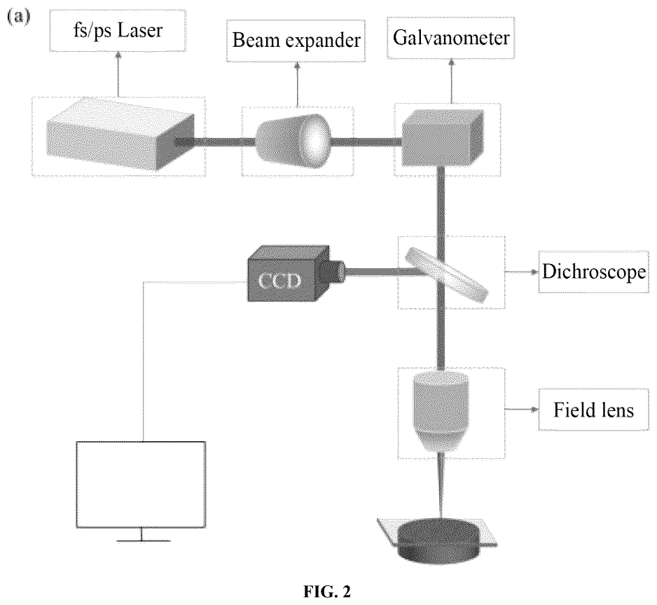

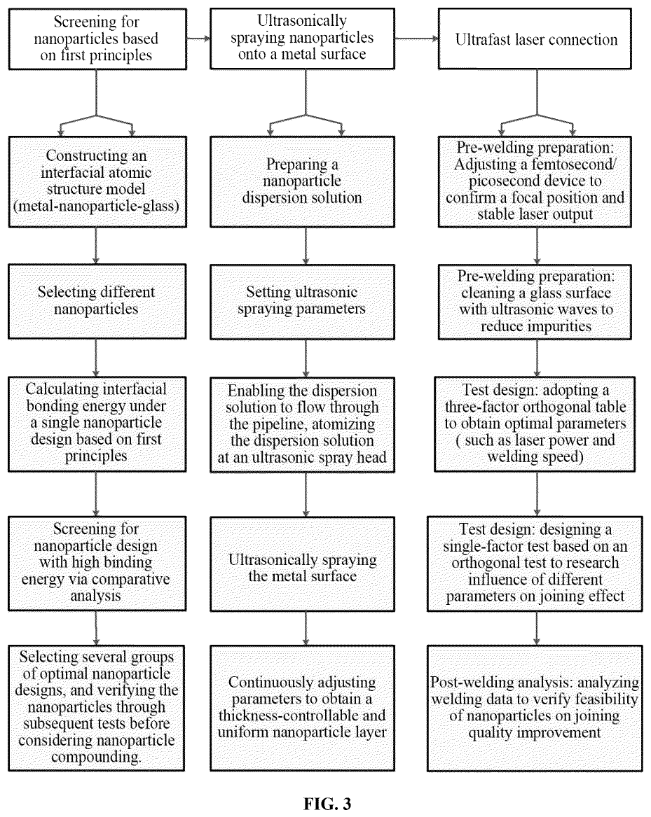

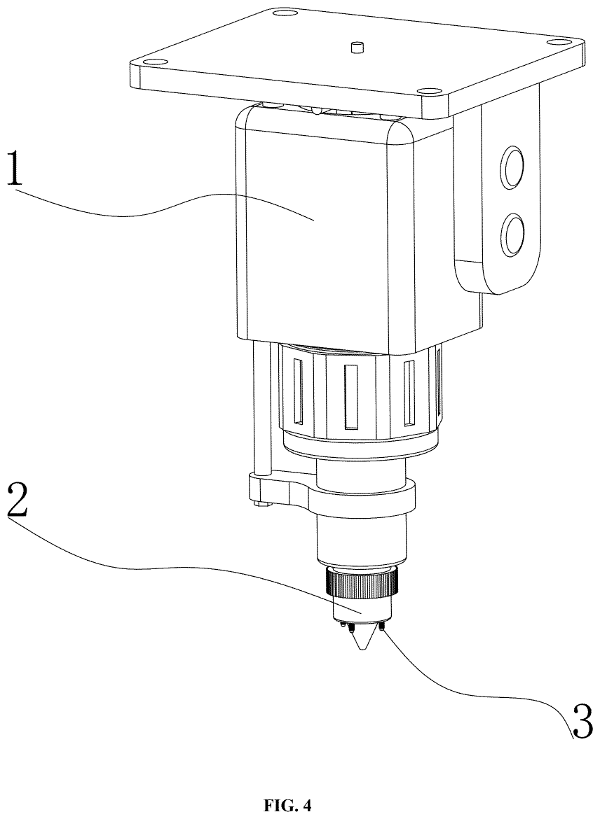

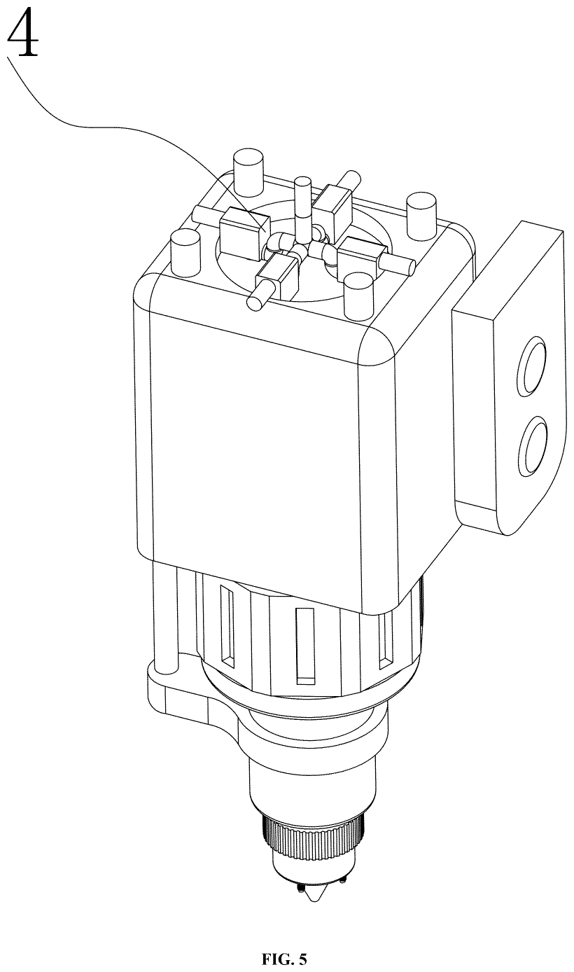

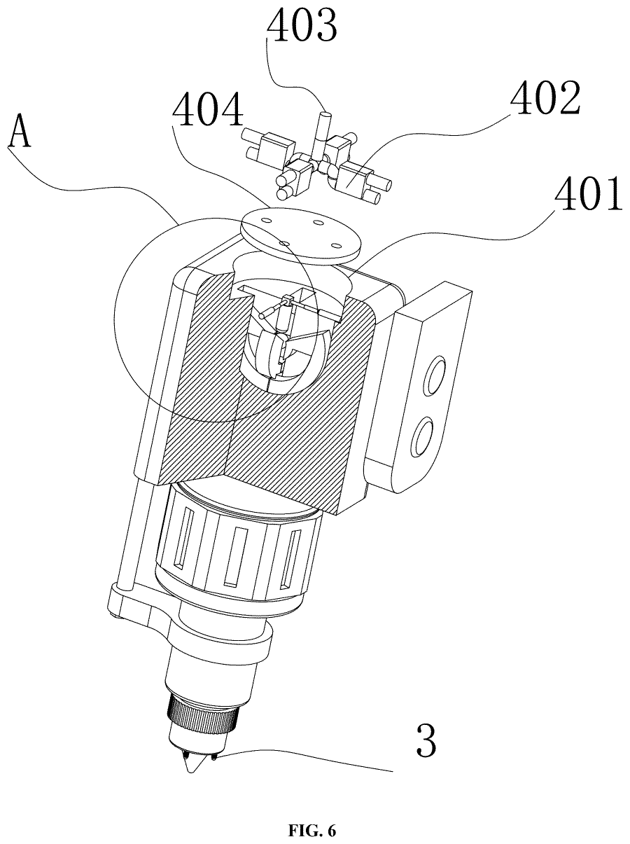

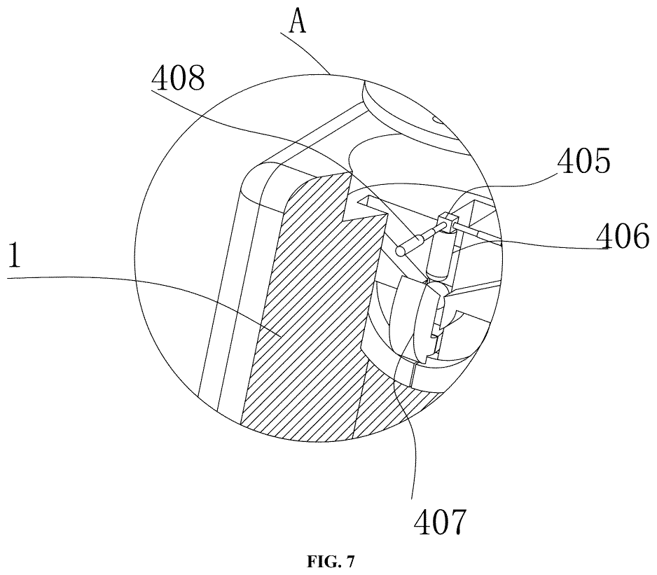

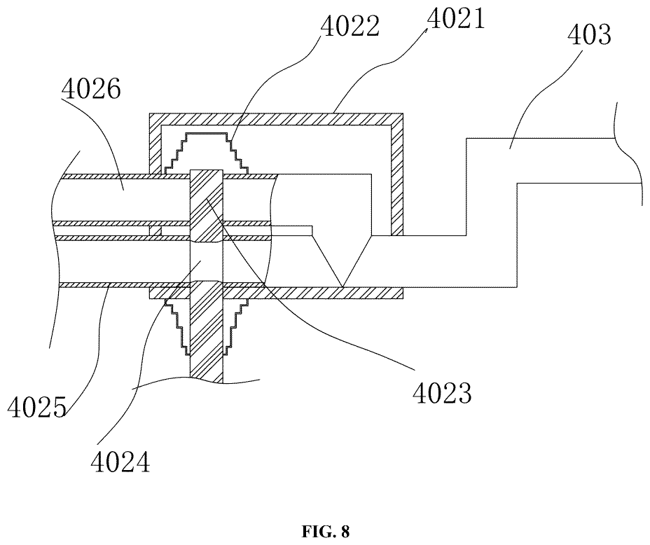

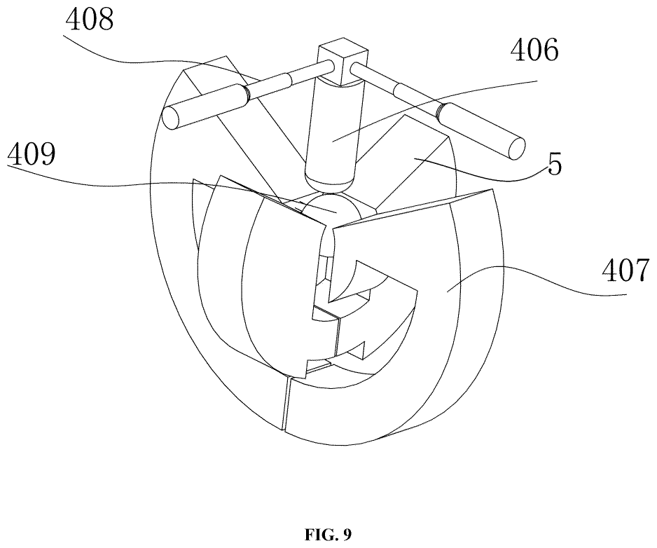

The present disclosure provides a laser welding method for enhancing glass-metal joining by ultrasonically spraying nanoparticles shown in FIG. 1 to FIG. 9, including a laser welding head, where an atomizing spraying device 4 is disposed on the laser welding head.

Specific steps of the method are as follows.

S1. selection of nanoparticles: screen for appropriate nanoparticles by means of first principles.

Rule of screening for the nanoparticles mainly depends on matching principle of bonding energy magnitude and thermodynamic characteristics.

Step one. Determine physical parameters of glass and metal, where the physical parameters specifically include a lattice parameter, a thermal expansion coefficient, and chemical composition.

Step two. Construct a glass-nanoparticle-metal interfacial atomic model using Material studio software based on the first principles, perform structural optimization on the interfacial model, calculate total energy E_{interface} of a glass-nanoparticle-metal system, and then calculate bonding energy E_{binding} of an interface by using the following formula; and screen for nanoparticles with high bonding energy by comparing interfacial bonding energy values of different nanoparticles;

$${E}_{binding} = \frac{{E}_{interface} - ( {E}_{glass} + {E}_{metal} + {E}_{nanopartical} )}{A} .$$

Step three. As brittle cracking is a common problem during a glass-metal joining process, nanoparticles are selected while considering whether a thermal expansion coefficient (α_{nanopartical}) of nanoparticles is close to a thermal expansion coefficient (α_{glass}) of the glass or a thermal expansion coefficient (αₘₑₜₐₗ) of a metal substrate, thereby avoiding interface cracking caused by thermal stress after welding; and screen for optimal nanoparticles by comparing similarity in thermal expansion coefficient between different nanoparticles and the metal substrate.

S2. Nano-spraying, including preparation of a nanoparticle dispersion solution, setting of ultrasonic parameters, and atomizing treatment of the dispersion solution.

S3. Coating parameter control: control a thickness and uniformity of a sprayed coating by controlling parameters such as ultrasonic power and frequency, treatment time, and a solution concentration, where a rough metal surface is filled with the nanoparticles, and interfacial gaps are greatly reduced;

Ultrasonic power: the ultrasonic power determines intensity and efficiency of liquid atomization, the higher the power, the higher the atomization intensity, the faster the liquid is dispersed into droplets, the higher the power, the higher the atomization efficiency, the greater the spraying rate, and the thicker the coating. However, excessively high power may cause droplet spattering, resulting in increased coating surface roughness and degraded uniformity. Therefore, the power is positively correlated with coating thickness, but excessively high or low power may affect the uniformity, and the power needs to be controlled within an appropriate range.

Ultrasonic frequency: the ultrasonic frequency mainly affects an atomization effect of the liquid, determines size and distribution of the droplets, ultrasonic waves with a higher frequency produce smaller droplets, and a diameter of the droplet is inversely proportional to the frequency. In general, the smaller the droplet, the better the uniformity of the coating, but excessively high frequency may result in overly fine droplets, accelerated evaporation, and reduced coating thickness. Therefore, the frequency is inversely proportional to the coating thickness and positively correlated with the uniformity.

Treatment time: this is spraying time, the longer the time, the thicker the coating.

Solution concentration: the higher the solution concentration, the higher the content of solid particles in the sprayed coating. Accordingly, the higher the concentration, the thicker the coating, but excessive concentration may affect uniformity and particle distribution. That is, the concentration is positively correlated with the coating thickness, while an overly high concentration tends to reduce uniformity (due to easy accumulation of particles).

S4. Pre-welding cleaning: clean the glass surface with ultrasonic waves to reduce impurities, thereby increasing welding effect.

S5. Laser welding: finally, spray nanoparticles around the laser welding head via the atomizing spraying device, followed by synchronous laser welding.

Specifically, the welding head comprises a first housing 1, a laser welding head 2, and nanoparticle spray heads 3. The first housing 1 is configured to connect an external device, the laser welding head 2 is mounted at the bottom of the first housing 1 for laser welding, and the nanoparticle spray heads 3 are annularly arranged around the laser welding head 2 for nanoparticle spraying. The first housing 1 is provided with the atomizing spraying device 4, the nanoparticle spray heads 3 communicate with the atomizing spraying device 4, and the atomizing spraying device 4 is configured to supply the dispersion solution to the nanoparticle spray heads 3.

Specifically, the atomizing spraying device 4 includes a main pipe 403 for externally connecting a liquid pump, and the bottom of the main pipe 403 communicates with the plurality of nanoparticle spray heads 3 for dispersion solution supply. A mounting groove 401 is provided in the atomizing spraying device 4, a partition plate 404 is disposed inside the mounting groove 401, and a movable block 405 is slidingly connected to the bottom of the partition plate 404. A push bar 406 is fixed to the bottom of the movable block 405, and electric push rods 408 are connected to at least two mutually perpendicular shafts of the movable block 405 for transverse pushing and longitudinal pushing. The electric push rod 408 is in contact with an outer surface of the movable block 405 without being connected thereto.

Specifically, the bottom of the push bar 406 is provided with two staggered rocker assemblies 407, a top surface of each of the two rocker assemblies 407 is V-shaped, and the V-shaped surface faces the push bar 406. The rocker assembly 407 is pried by the movement of the push bar 406 to form a rocker state, enabling the push bar 406 to move to one side to pry one end of the corresponding rocker assembly 407, and the other end of the rocker assembly to tilt upward. A branch at the bottom of the main pipe 403 is correspondingly plugged by a plugging assembly.

Specifically, a sphere 409 is disposed at the center of the rocker assembly 407. The rocker assembly 407 is slidably disposed inside the first housing 1, a sliding chute is arc-shaped for supporting the rocker assembly while allowing the rocker assembly to slide. One of the rocker assemblies 407 is provided with two arc-shaped structures, and a diameter of the arc-shaped structure is greater than an arc diameter of the other rocker assembly 407. A plurality of arc-shape structures of the rocker assembly 407 are connected to the sphere 409 via a universal joint.

Specifically, the plugging assembly comprises a plurality of branch pipes connected to the main pipe 403 and communicate with the plurality of nanoparticle spray heads 3 through the plurality of branch pipes 4025, and a middle plugging member 402 is arranged on an outer side of the branch pipe 4025.

The middle plugging member 402 includes a second housing 4021 connected to the outside of the main pipe 403, a return pipe 4026 connected to one end of the main pipe 403 via a tee valve is further disposed inside the second housing 4021, and movable plugging members 4023 are vertically disposed on the branch pipe 4025. A plurality of movable plugs 4023 are respectively connected to arc-shaped tops of the plurality of rocker assemblies 407 via universal joints, and are slidably connected to the partition plate 404. The movable plugging member 4023 is driven to move by the upward tilting of one end of the rocker assembly 407 to plug the branch pipe 4025, thereby cutting off liquid supply to the corresponding nanoparticle spray head 3.

Embodiment 1: At first, appropriate nanoparticles corresponding to a selected metal are selected based on first principles, then an ultrasonic spraying technology is used to uniformly spray the nanoparticles onto a rough metal surface, the thickness and uniformity of the coating can be controlled by controlling ultrasonic power and frequency, treatment time, solution concentration, and other parameters, so that the rough metal surface can be filled with the nanoparticles, and the interfacial gaps can be greatly reduced. On this basis, there is no need of any external force for compression, an ultrashort pulse-width laser picosecond or femtosecond is applied to a glass-metal joining interface, and high-quality micro-nano joining at the interface is achieved by adjusting parameters such as laser power, a repetition frequency, defocus amount, and a scanning speed. To select appropriate nanoparticles, nanoparticles with high bonding energy at a metal-glass interface is selected based on the first principles. When the metal-nanoparticle-glass interfacial atomic model is constructed, as the glass is of an amorphous structure, the glass is replaced with a crystalline structure of the same element that is stable at room temperature. For instance, fused silica can be substituted with α-quartz crystal, which is stable at the room temperature, for calculation. The ultrasonic spraying technology is adopted herein to ensure uniform spreading of the nanoparticles. After being prepared into the dispersion solution, the nanoparticles are atomized at a nozzle and then uniformly sprayed onto the metal surface.

Embodiment 2: The atomizing spraying device 4 is provided to synchronize movement of a rear end of the welding head by using the electric push rod 408 during laser welding. When the welding head moves to one side, the electric push rod 408 extends to one end or retracts accordingly, so that the push bar 406 can be used to push the corresponding rocker assembly 407 to tilt up, causing an arc-shaped structure on a rear side of a moving direction thereof to jack up the movable plugging member 4023 connected to the top of the arc-shaped structure to plug a corresponding branch pipe 4025. This enables the nanoparticle spray heads 3 located behind the moving direction to stop spraying, thereby reducing waste while ensuring uniform spraying.

Embodiment 3: On the basis of Embodiment 2, when the movable plugging member 4023 moves upward to block the branch pipe 4025, that is, the push bar 406 moves toward the V-shaped surface of the rocker assembly 407 without coming into contact with the same, a through hole 4024 is synchronously moved to the return pipe 4026, the liquid supply of the nanoparticle spray head 3 at this position is cut off, but the liquid here is collected by the return pipe 4026 and flows back to the liquid pump for recycling. When a welding moving speed increases, a push distance of the corresponding electric push rod 408 becomes longer, leading to the increase in a jack-up height of the movable plugging member 4023. When the branch pipe 4025 is plugged, the return pipe 4026 is further plugged gradually, so that the total liquid flow rate of the main pipe 403 remains unchanged, and the delivery pressure of the other three paths of dispersion solution increases, promoting to match the welding speed and improving spraying efficiency and achieving the purpose of automatic adjustment. During this period, a plurality of telescopic sealing covers 4022 arranged between the return pipe 4026, the branch pipe 4025 and the second housing 4021 may also achieve synchronous sealing when the movable plugging member 4023 extends out.

Finally, it should be noted that the foregoing is merely a preferred embodiment of the present disclosure and is not intended to limit the present disclosure. Although the present disclosure has been described in detail with reference to the foregoing embodiments, those skilled in the art may still make modifications to the technical solutions recorded in the foregoing embodiments, or perform equivalent replacements for part of the technical features thereof. Any modifications, equivalent replacements, improvements and the like made within the spirit and principles of the present disclosure shall fall within the scope of protection of the present disclosure.

What is claimed is:

1. A laser welding method for enhancing glass-metal joining by ultrasonically spraying nanoparticles, comprising a laser welding head, wherein an atomizing spraying device (4) is disposed on the laser welding head;
specific steps of the method are as follows.
S1. selection of nanoparticles: screening for appropriate nanoparticles by means of first principles, wherein
the screening mainly relies on a matching principle of a binding energy magnitude and thermodynamic properties;
the matching principle of the binding energy magnitude and thermodynamic properties specifically comprises the following steps:
Step one: determining physical parameters of glass and metal, wherein the physical parameters specifically comprise a lattice parameter, a thermal expansion coefficient, and chemical composition;
Step two: constructing a glass-nanoparticle-metal interfacial atomic model using Material studio software based on the first principles, performing structural optimization on the interfacial model, calculating total energy E_{interface} of a glass-nanoparticle-metal system, and then calculating bonding energy E_{binding} of an interface by using the following formula; and
screening for nanoparticles with high bonding energy by comparing interfacial bonding energy values of different nanoparticles;
$${E}_{binding} = \frac{{E}_{interface} - ( {E}_{glass} + {E}_{metal} + {E}_{nanopartical} )}{A} ;$$
wherein E_{interface} is total energy of the glass-nanoparticle-metal system, E_{binding} is bonding energy of the interface; E_{glass} is energy of the glass; Eₘₑₜₐₗ is energy of the metal; E_{nanopartical} is energy of nanoparticles; and A is an area of a welding path;
Step three: as brittle cracking is a common problem during a glass-metal joining process, selecting nanoparticles while considering whether a thermal expansion coefficient α_{nanopartical} of nanoparticles is close to a thermal expansion coefficient α_{glass} of the glass or a thermal expansion coefficient of αₘₑₜₐₗ of a metal substrate, thereby avoiding interface cracking caused by thermal stress after welding; and screening for optimal nanoparticles by comparing similarity in thermal expansion coefficient between different nanoparticles and the metal substrate;
S2: nano-spraying, comprising preparation of a nanoparticle dispersion solution, setting of ultrasonic parameters, and atomizing treatment of the dispersion solution;
S3: coating parameter control: controlling a thickness and uniformity of a sprayed coating by controlling parameters such as ultrasonic power and frequency, treatment time, and a solution concentration, wherein a rough metal surface is filled with the nanoparticles, and interfacial gaps are greatly reduced;
S4: pre-welding cleaning: cleaning the glass surface with ultrasonic waves to reduce impurities; and
S5: laser welding: finally, spraying the nanoparticles around the laser welding head by using the atomizing spraying device (4), followed by laser welding.

2. The laser welding method for enhancing glass-metal joining by ultrasonically spraying nanoparticles according to claim 1, wherein in S3, the ultrasonic power determines intensity and efficiency of liquid atomization, the higher the power, the higher the atomization intensity, the faster the liquid is dispersed into droplets, the higher the power, the higher the atomization efficiency, the greater the spraying rate, and the thicker the coating.

3. The laser welding method for enhancing glass-metal joining by ultrasonically spraying nanoparticles according to claim 1, wherein in S3, the ultrasonic frequency mainly affects atomization effect of the liquid, and determines size and distribution of the droplets, the ultrasonic waves with higher frequency produce smaller droplets, and a diameter of the droplet is inversely proportional to the frequency; the smaller the droplet, the better the uniformity of the coating; and the frequency is inversely proportional to a thickness of the coating and positively correlated with the uniformity;
treatment time: that is spraying time, the longer the time, the greater the coating thickness; and
solution concentration: the greater the solution concentration, the higher a solid particle content in the sprayed coating; and the higher the concentration, the thicker the coating.

4. The laser welding method for enhancing glass-metal joining by ultrasonically spraying nanoparticles according to claim 1, wherein the welding head comprises a first housing (1), a laser welding head (2), and nanoparticle spray heads (3); the first housing (1) is configured to connect an external device, the laser welding head (2) is mounted at the bottom of the first housing (1) for laser welding, the nanoparticle spray heads (3) are annularly arranged around the laser welding head (2) for nanoparticle spraying; the first housing (1) is provided with the atomizing spraying device (4), the nanoparticle spray heads (3) communicate with the atomizing spraying device (4), and the atomizing spraying device (4) is configured to supply the dispersion solution to the nanoparticle spray heads (3).

5. The laser welding method for enhancing glass-metal joining by ultrasonically spraying nanoparticles according to claim 4, wherein the atomizing spraying device (4) comprises a main pipe (403) for externally connecting a liquid pump, and the bottom of the main pipe (403) communicates with the plurality of nanoparticle spray heads (3) for dispersion solution supply; a mounting groove (401) is provided in the atomizing spraying device (4), a partition plate (404) is disposed inside the mounting groove (401), and a movable block (405) is slidingly connected to the bottom of the partition plate (404); a push bar (406) is fixed to the bottom of the movable block (405), and electric push rods (408) are connected to at least two mutually perpendicular shafts of the movable block (405) for transverse pushing and longitudinal pushing; and the electric push rod (408) is in contact with an outer surface of the movable block (405) without being connected thereto.

6. The laser welding method for enhancing glass-metal joining by ultrasonically spraying nanoparticles according to claim 5, wherein the bottom of the push bar (406) is provided with two staggered rocker assemblies (407), a top surface of each of the two rocker assemblies (407) is V-shaped, and the V-shaped surface faces the push bar (406); the rocker assembly (407) is pried by the movement of the push bar (406) to form a rocker state, enabling the push bar (406) to move to one side to pry one end of the corresponding rocker assembly (407) and enabling the other end of the rocker assembly to tilt upward; and a branch at the bottom of the main pipe (403) is correspondingly plugged by a plugging assembly.

7. The laser welding method for enhancing glass-metal joining by ultrasonically spraying nanoparticles according to claim 6, wherein a sphere (409) is disposed at the center of the rocker assembly (407); the rocker assembly (407) is slidably disposed inside the first housing (1), a sliding chute is arc-shaped for supporting the rocker assembly while allowing the rocker assembly to slide; one of the rocker assemblies (407) is provided with two arc-shaped structures, and a diameter of the arc-shaped structure is greater than an arc diameter of the other rocker assembly (407); and a plurality of arc-shape structures of the rocker assembly (407) are connected to the sphere (409) via a universal joint.

8. The laser welding method for enhancing glass-metal joining by ultrasonically spraying nanoparticles according to claim 7, wherein the plugging assembly comprises a plurality of branch pipes connected to the main pipe (403) and communicate with the plurality of nanoparticle spray heads (3) through the plurality of branch pipes (4025), and a middle plugging member (402) is arranged on an outer side of the branch pipe (4025);
the middle plugging member (402) comprises a second housing (4021) connected to the outside of the main pipe (403), a return pipe (4026) connected to one end of the main pipe (403) via a tee valve is further disposed inside the second housing (4021), movable plugging members (4023) are vertically disposed on the branch pipe (4025); a plurality of movable plugs (4023) are respectively connected to arc-shaped tops of the plurality of rocker assemblies (407) via universal joints, and are slidably connected to the partition plate (404); and the movable plugging member (4023) is driven to move by the upward tilting of one end of the rocker assembly (407) to plug the branch pipe (4025), thereby cutting off liquid supply to the corresponding nanoparticle spray head (3).
